(19) United States
(12) Patent Application Publication
(10) Pub. No.: US 2005/0163417 A1
(43) Pub. Date: Jul. 28, 2005

(54) Optical switch with a micro-mirror and method for production thereof

(75) Inventor: Serge Valette, Grenoble (FR)

Correspondence Address: PILLSBURY WINTHROP SHAW PITTMAN, LLP, P.O. BOX 10500, MCLEAN, VA, 22102, US

(73) Assignee: Teem Photonics, Meylan (FR)

(21) Appl. No.: 10/501,528

(22) PCT Filed: Jan. 16, 2003
(86) PCT No.: PCT/FR03/00130

(30) Foreign Application Priority Data
Jan. 18, 2002 (FR) 02/00598

(51) Int. Cl. G02B 6/26; G02B 6/42

(52) U.S. Cl. 385/16

(57) ABSTRACT

The invention concerns an optical switch using a micromirror and its method of fabrication. This optical switch comprises at least one input optical path (31) and at least a first and a second output optical path (35,37) and a micromirror (41) able to move between an output of the input optical path and inputs of the first and second output optical paths. The micromirror comprises a reflector part (13) and an actuating part (15) able to drive the reflector part in rotation. The invention applies to all areas using optical switches, and in particular the sphere of optic telecommunications.

### Technical Field

The present invention pertains to an optical switch with micromirror and its method of fabrication.

More precisely, it concerns an optical switch able to transfer a light wave conveyed by an input optical path towards a first or a second output path.

The invention finds applications in all areas which use optical switches, and in particular the area of optic telecommunications.

Prior Art

To enable the switching of a light beam from an input optical path to any output path, there currently exist two families of switches:
one of the switch families consists of bringing the light beam via a mechanical system able to convey said light beam (for example a mobile beam provided with an optical guide) to the input of one of the output optical paths; this principle is described for example in U.S. Pat. No. 5,078,514,
the other switch family uses a micromirror able to move between the input optical path and the two output optical paths so as to enable either transmission passing of the light beam from the input path to one of the output paths, or reflection passing of the beam from the input path to the other output path.

The invention concerns this latter family of switches.

The interposing of micromirrors in front of an optical beam is widely used in free space. FIGS. 1a and 1b and FIGS. 2a and 2b illustrate the use of micromirrors in free space, able to move along two positions between an input fibre 1 and two output fibres 3 and 5.

In FIGS. 1a and 1b, the optical axis of fibre 3 lies in the optical alignment of the axis of fibre 1, while the axis of fibre 5 is perpendicular to the axis of fibre 1.

Therefore, when the micromirror is in a position in which it is not interposed between fibres 1 and 3 on the optical axis of said fibres, the light beam leaving fibre 1 is transmitted to fibre 3; and when the micromirror is in a position in which it is interposed between fibres 1 and 3 on the optical axis of said fibres, the light beam leaving fibre 1 is reflected by the mirror and is transmitted to fibre 5.

In the case shown FIGS. 1a and 1b, the micromirror 7 used has translation movement. Arrows 8a and 8b represent the translation movement of the mirror in FIGS. 1a and 1b respectively. This translation movement is made in a plane containing the plane of the micromirror.

In the case shown FIGS. 2a and 2b, the optical axis of fibre 3 also lies in the optical alignment of the axis of fibre 1, while the axis of fibre 5 is arranged at 45° to the axis of fibre 1. The micromirror 11 used has rotational movement about a hinge 9 which is perpendicular to the optical axis of fibre 1 and which is contained in the plane of the mirror. Arrow 10 in FIG. 2b represents the rotation movement of the mirror which is able to move about 90°. Therefore, when the micromirror is below the optical axis of fibre 1, the light beam conveyed by fibre 1 is transmitted to fibre 3, while when the micromirror is interposed so that the light beam arriving from fibre 1 is 45° incident to it, said beam is reflected towards fibre 5.

The rigid micromirrors used in these structures are difficult to transpose to integrated optics since the fabrication technologies for optical guides and for mirrors are different and hence not easily compatible.

In integrated optics, known switches using the principle of light beam transmission or reflection are obtained through the movement of two fluids (an air bubble in a liquid for example) in a recess arranged in a support comprising optical guides forming the input and output paths, one of the fluids enables transmission of the beam and the other fluid enables its reflection. These structures raise problems of reliability having regard in particular to the movement of a fluid in a recess of restricted volume with problems of pollution.

Also, the rigid micromirrors used in free space are generally controlled by electrostatic forces and the electrostatic voltages required to obtain translation or rotation of the mirror must be sufficient to move the whole mirror. The greater the size of the mirror, the higher the required forces.

### DESCRIPTION OF THE INVENTION

The present invention sets out to propose an optical switch using a rigid micromirror which can be used both in integrated optics and in free space optics and therefore not having the prior art reliability problems of switches in integrated optics.

A further objective of the invention is to propose an optical switch using a micromirror able to be controlled by voltages which may be lower than those for previously described micromirrors.

Further objectives of the invention are to propose an optical switch using a micromirror minimizing optical losses and able to have the fastest access time possible, and which is insensitive to polarization and wavelength.

Finally, a further purpose of the invention is to put forward a method for fabricating a switch in integrated optics which is simple, easy to implement and hence offering good production yield.

More precisely, the invention concerns an optical switch comprising at least one input optical path, at least a first and a second output optical paths and a micromirror able to move between an output of the input optical path and inputs of the first and second output optical paths, the input optical path and the first output optical path having an identical optical axis, called first optical axis, and the second output optical path having an optical axis called second optical axis, the micromirror comprising a reflector part and an actuating part having an axis of rotation and able to drive the reflector part in rotation about a plane called a tilt plane, this tilt plane being perpendicular to a plane containing the axis of rotation, and said reflector part comprising at least one reflective face in a plane parallel to the tilt plane able to reflect a light wave derived from the input path towards the second output path, the first and second optical axes respectively forming an angle α relative to an axis of symmetry, the optical switch further including a control device to tilt the reflector part, this control device comprising a first set of electrodes arranged on the actuating part, a second set of electrodes arranged facing the first set, and means for applying a potential difference between the sets of electrodes.

According to one particular embodiment of the invention, the optical switch comprises a first input optical path associated with a first and a second output optical paths, and a second input optical path associated with a third and a fourth output optical paths, the micromirror being able to interpose itself either between an output of the first input optical path and the inputs of the first and second output optical paths, or between an output of the second input optical path and inputs of the third and fourth output optical paths.

According to the invention, the input and output optical paths are chosen independently from one another from among optical fibres or optical guides.

Advantageously, the input and output optical paths are respectively optical guides in a substrate, said substrate also including a recess able to allow rotation of the reflector part about the so-called tilt plane.

The fabrication of a switch in integrated optics using a rigid micromirror makes it possible to overcome the prior art reliability problems of switches in integrated optics.

Also, since the width of the recess is related to applied fabrication technologies, it can be narrow thereby minimizing the distance travelled by light waves outside the optical guides and hence minimizing optical losses.

In addition, according to the invention, the tilt plane of the reflector part and the axis of rotation of the actuating part are perpendicular. The reflector part which comprises the reflective face and the actuating part which generally comprises a set of electrodes and forms a zone of attraction are decoupled, which enables the micromirror of the invention to use a lever effect which reduces the movement of the reflector part.

The movement of the micromirror generally being obtained through the use of electrostatic forces generated by two sets of electrodes to which a potential difference is applied, and since the zone of attraction is independent from the reflector part, the surface of the electrodes of the actuating part can be a large surface allowing a reduction in the forces required to tilt the reflector part and hence in control voltages. The same applies to the inter-electrode space which may be reduced, which also enables a reduction in the forces required to tilt the reflector part.

Angle α is advantageously non-zero.

Each set of electrodes comprises at least one electrode.

The micromirror of the invention advantageously comprises at least one limit stop able to limit movement of the reflector part.

This limit stop, for switches with a single input path and two output paths for example, is in the form of a boss at one end of the reflector part, the width of said boss in a plane perpendicular to the tilt plane is greater than the width of the recess along the same plane.

The switch of the invention makes it possible to have rapid response time, in the order of a ms for example or a few dozen μs, due in particular to the dimensions of the micromirror which may be small. It provides for insensitivity to polarization and wave length on account of the use of a transmission effect or mirror reflection effect to achieve switching.

Evidently, the micromirror is not limited to total reflection. The reflector part of the micromirror may allow selective reflection of only one polarization or only some wave lengths and respectively transmit the other polarization or other wave lengths, the micromirror then acting as filter.

A further subject of the invention is a method for fabricating a switch of the invention in integrated optics.

This methods comprises the following steps:
a) in a first substrate, fabricating at least one input optical guide, a first and a second output optical guide, a recess, and a second set of electrodes, the input optical guide and the first output optical guide having an identical optical axis called first optical axis, the second output optical guide having an optical axis called second optical axis, the first and second optical axes respectively forming an angle α relative to an axis of symmetry (S),
b) in a second substrate, fabricating a micromirror and a first set of electrodes, the micromirror being able to move between an output of the input optical guide and inputs of the first and second output optical guides, the micromirror comprising a reflector part and an actuating part having an axis of rotation and able to drive the reflector part in rotation about a plane called tilt plane, this tilt plane being perpendicular to a plane containing the axis of rotation, and said reflector part comprising at least one reflective face in a plane parallel to the tilt plane, able to reflect a light wave derived from the input optical guide towards the second output optical guide,
c) adding the second substrate onto the first substrate so that the micromirror is able to tilt within the recess.

Evidently, these steps may also comprise the fabrication of other elements depending upon intended applications.

Steps a), b) and c) may be performed in this order or in different order. Or they may be interlinked. In particular, the adding of the second substrate onto the first substrate may be performed before complete fabrication of the micromirror.

When the actuating part of the micromirror is conductive, this actuating part may then act as the first set of electrodes; the fabrication of said first set is then merged with the fabrication of the actuating part of the micromirror.

According to one first embodiment, the second substrate is a stack of a first carrier layer, a second layer and a third layer intended to form the micromirror.

According to one advantageous embodiment, the first carrier layer is a silicon layer, the second layer is a silicon oxide layer and the third layer is a silicon film, the micromirror being fabricated in said film.

Advantageously, the second substrate is a Silicon On Insulator (SOI) wafer obtained for example by adding a film of monocrystalline silicon onto a silicon carrier comprising a thermal oxide layer. This silicon film is optionally epitaxied to desired film thickness.

Step b) of the micromirror fabrication comprises the following steps:
etching the first carrier layer and then the second layer so as to make an opening in the substrate exposing part of the third layer,
etching the third layer so as to form the patterns corresponding to the reflective and actuating parts of said micromirror and releasing said parts from the remainder of the third layer allowing said layer to subsist at the axis of rotation of the actuating part so that the micromirror remains joined to the second substrate
depositing a reflective layer on all or part of a side face of the reflector part so as to form the reflective face of the micromirror.

If a reflector part with a limit stop is to be made, etching of the third layer is conducted so as to obtain a pattern for the reflector part comprising said limit stop.

Other characteristics and advantages of the invention will be more readily seen in the following description with reference to the appended drawings. This description is given solely for illustrative purposes and is non-restrictive.

### BRIEF DESCRIPTION OF THE DRAWINGS

FIGS. 1a and 1b illustrate a first example of a known switch in free space,

FIGS. 2a and 2b illustrate a second example of known switch in free space,

FIGS. 3a, 3b and 3c illustrate an example of embodiment of a switch according to the invention in integrated optics,

FIGS. 4a and 4b illustrate a variant of the preceding example in which the micromirror comprises a limit stop,

FIG. 5 shows another example of a switch of the invention with several inputs,

FIGS. 6a to 6g shows an example of embodiment of the switch in FIGS. 3a, 3b and 3c.

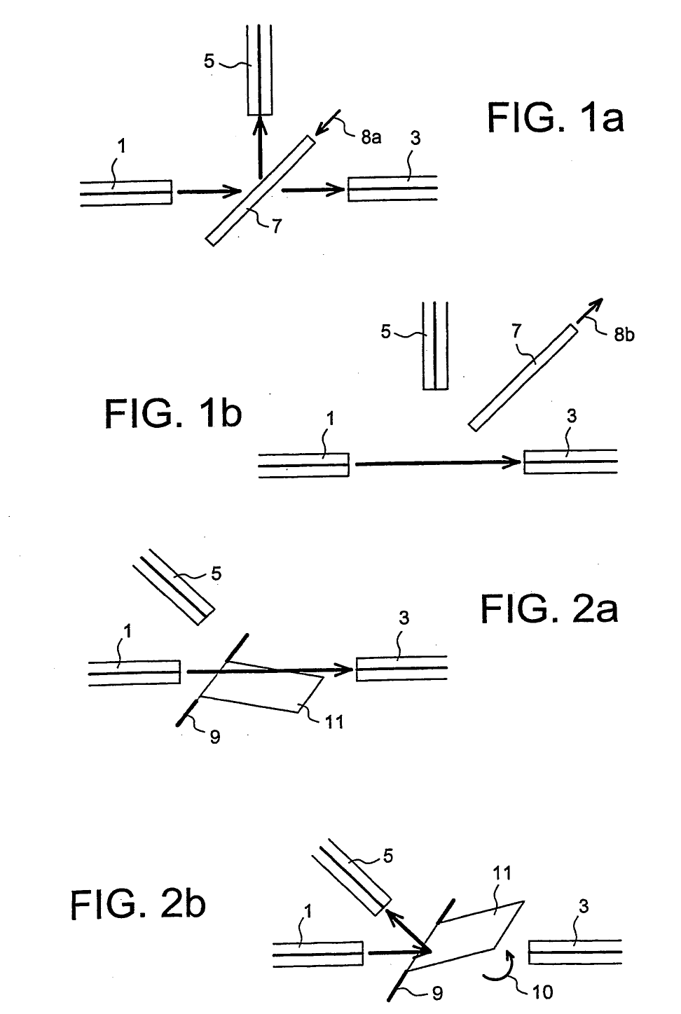

### DETAILED DESCRIPTION OF EMBODIMENTS OF THE INVENTION

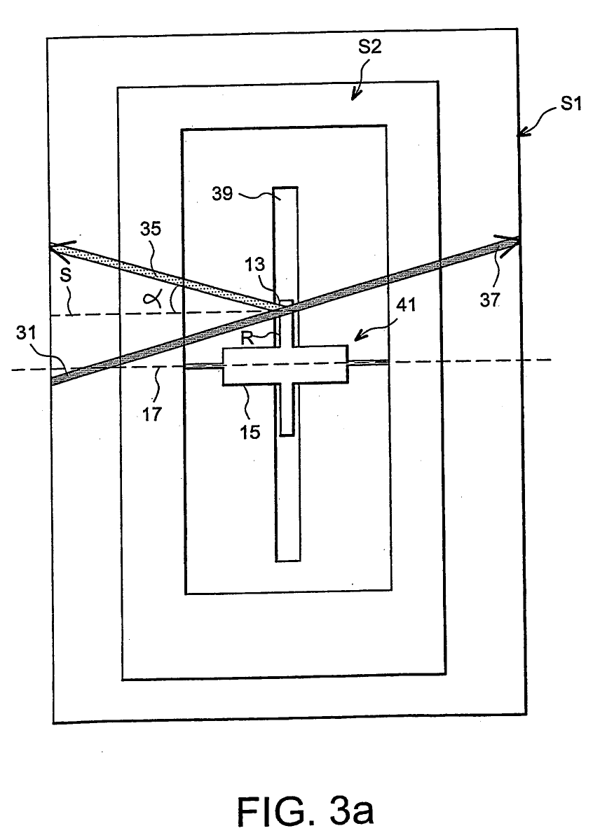

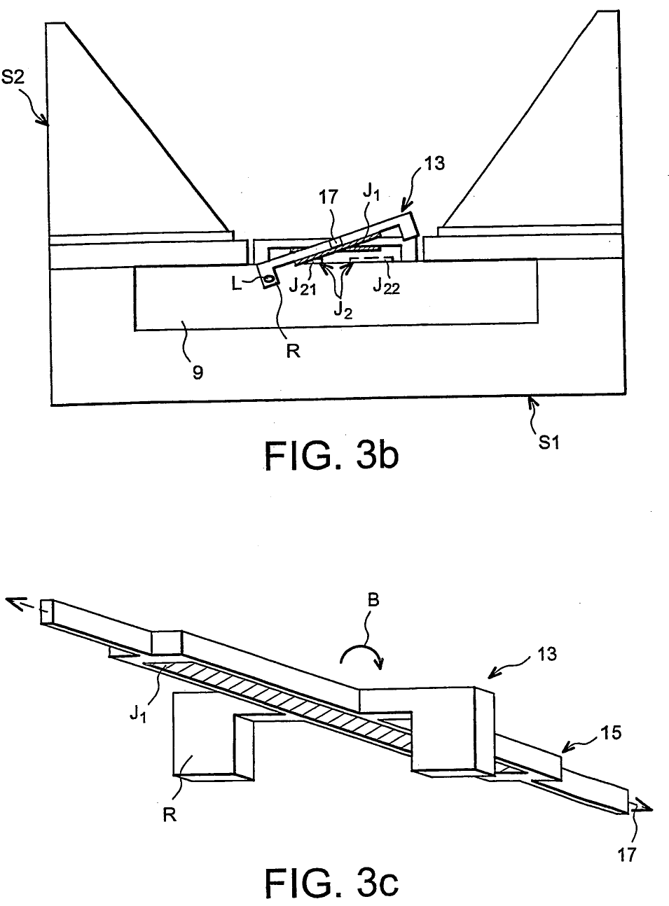

FIGS. 3a, 3b and 3c illustrate an example of embodiment of a switch of the invention made in integrated optics.

FIG. 3a is an overhead view of said switch.

FIG. 3b is a cross-section of the switch along a plane containing the reflective face of the micromirror.

FIG. 3c is a perspective view of the micromirror used in this switch.

In a substrate S1, an input optical path 31 and two output optical paths 35 and 37 are fabricated. These optical paths are formed in this example by optical guides.

As a general rule, an optical guide consists of a central part generally called the core and surrounding media positioned all around the core which may be identical or different. To achieve confinement of the light in the core, the refractive index of the medium forming the core must be different to and in most cases greater than those of the surrounding media. The guide may be a planar guide when light confinement is made in a plane containing the direction of light propagation, or a microguide when light confinement is made in two directions transverse to the direction of light propagation.

To simplify the description, the guide will be likened to its central part or core, and only the cores of these guides are shown in all the figures.

Also, all or part of the surrounding media shall be called “substrate”, it being understood that when the guide is not or only scarcely buried one of the surrounding media may be outside the substrate being air for example.

Depending upon the type of technique used, the substrate may be monolayer or multilayer.

Also, depending upon applications, an optical guide in a substrate may be more or less buried in this substrate and may in particular comprise portions of guide buried at varying depths. This is particularly the case in ion exchange technology in glass. To simplify the description, the guides are shown at a constant depth in the substrate.

In FIGS. 3a, 3b and 3c the optical axis of guides 31 and 37 is the same, while the optical axis of guide 35 forms an angle 2α with the optical axis of guide 31. Guides 31 and 35 are arranged symmetrically relative to an axis of symmetry S.

The output of guide 31 and the input of guide 35 firstly and the input of guide 37 secondly are separated by a recess 39 able to allow tilting of a micromirror 41 about a tilt plane B.

The micromirror 41 comprises a reflector part 13 and an actuating part 15 having an axis of rotation 17 parallel to the axis of symmetry S; the reflector part and the actuating part being integral with one another, the actuating part is able to drive the reflector part in rotation about a plane called a tilt plane. The tilt plane of the reflector part is perpendicular to a plane containing the axis of rotation.

The reflector part comprises at least one reflective face R in a plane parallel to the tilt plane of the reflector part. This face R is able to reflect a light wave derived from guide 31 towards guide 35.

In the figures, the reflective face is shown as a dotted line.

Therefore, when the reflector part of mirror 41 is interposed between the optical axis of guide 31, the face R which then faces the output of guide 31 and the input of guide 35 reflects the light wave derived from guide 31 towards guide 35.

On the contrary, when the reflector part of mirror 41 is not interposed in the optical axis of guide 31, the light wave derived from guide 31 is transmitted directly via recess 9 to guide 37.

The switch further includes a control device controlling rotation of the actuating part so that the latter induces tilting of the reflector part which can then be interposed or not in the optical axis. This control device includes for example as shown in FIG. 3b a first set of electrodes J1 arranged on the actuating part, a second set of electrodes J2 arranged on the substrate, facing the first set, and means (not shown) for applying a potential difference between the sets of electrodes.

Each set of electrodes comprises at least one electrode. In this example, set J1 comprises a single electrode and set J2 comprises two electrodes J21 and J22 facing the electrode of set J1. Therefore, the application of a different potential difference between each of the electrodes of set J2 and the electrode of set J1 makes it possible tilt the reflector part towards the electrode of set J2 for which the potential difference is the greatest.

Hence two positions may be defined:
a first position (shown FIG. 3b) in which one end of the reflector part moves down into recess 9 through the electrostatic forces between electrodes J1 and J21; the reflective face covering at least this end then intercepts the light wave (shown as an ellipse L on surface R) and enables reflection of said wave, and
   a second position in which the end of the reflector part moves up out of recess 39 through the electrostatic forces between electrodes J1 and J22, the reflective face no longer-intercepts the light wave which is therefore transmitted.

The reflector part of the micromirror has a side face which is fully or partly reflective; the part of the side face able to reflect is the reflective face. In FIGS. 3b and 3c, the side face is entirely reflective and merges with the reflective face, but evidently only that part (effective part) of this side face intended to be intercept the optical axis could have been reflective.

The actuating part (see FIGS. 3a and 3c) is formed by a central zone on which electrode J1 is arranged whose dimensions are close to the dimensions of the central zone, and by a narrower zone either side of the central zone arranged along the axis of rotation to connect the central zone to a rigid structure. This narrower zone forms a hinge for the actuating part.

In this example of embodiment of a switch in integrated optics, the rigid structure to which the mobile part is joined consists of a second substrate S2 arranged on substrate 1.

In the invention, the reflector part is able to move along the tilt plane perpendicular to a plane containing the axis of rotation 17 of the actuating part. The latter enables tilting of the reflector part under a lever effect. The effective part of the reflective face may, on this account, be distanced away from the axis of rotation and the inter-electrode space may be small (for example a few μm).

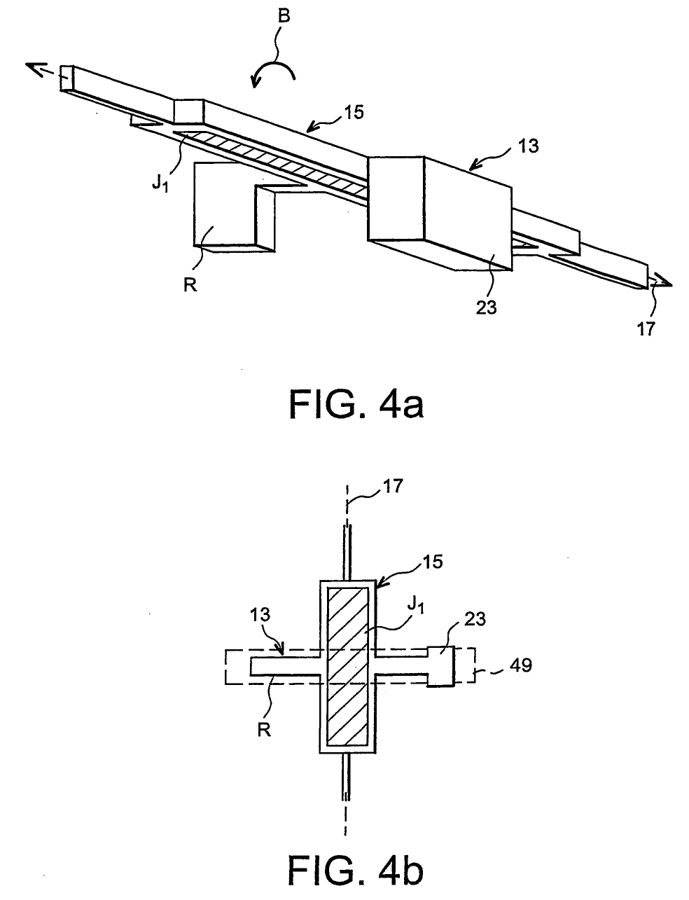

FIGS. 4a and 4b show a variant of embodiment of a micromirror of a switch in integrated optics, FIG. 4a is a perspective view of the micromirror and FIG. 4b is an underside view of the mirror.

This micromirror, as previously, comprises an actuating part 15 and a reflector part 13. These parts are the same as those described with reference to FIGS. 3a to 3c with the exception that the reflector part also comprises a limit stop 23 at one of its ends opposite the end having the effective part of the reflective face.

This limit stop limits the movement of the reflector part outside the recess. In this way, it particularly enables locking of the micromirror in a position in which the reflector part is not interposed in front of the optical beam.

The limit stop consists for example of a boss at the end of the reflector part; the width of said boss in a plane perpendicular to the tilt plane is greater than the width of the recess along this same plane.

By way of indication, the form of recess 49 along this plane is shown as a dotted line.

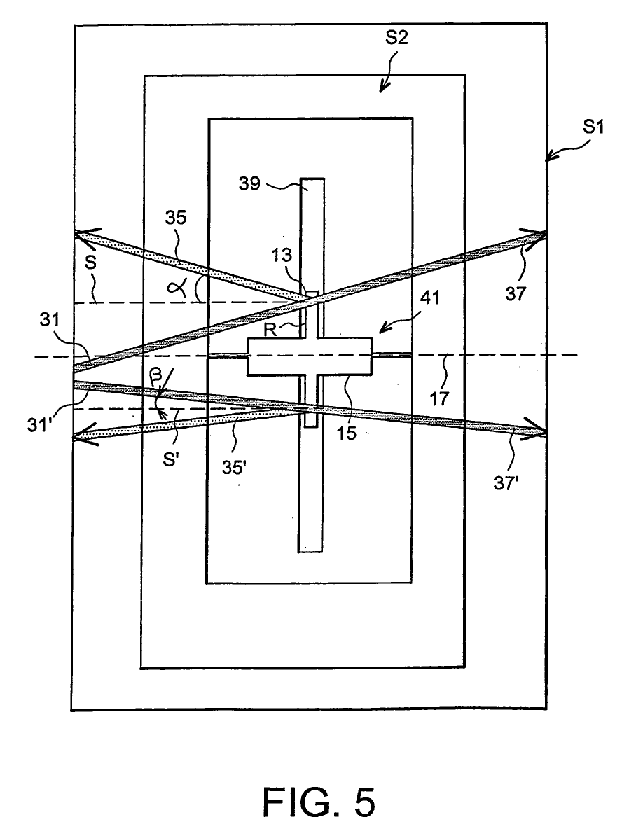

FIG. 5 shows another example of a switch of the invention in integrated optics from an overhead view. This switch comprises the same elements as FIG. 3a and in particular a first input guide 31 associated with a first output guide 35 and with a second output guide 31, but it also includes a second input guide 31′ associated with a third and fourth output optical guide 35′ and 37′. Guides 31′ and 35′ are positioned symmetrically relative to an axis of symmetry S′ and with this axis respectively form an angle β.

The reflector part 13 of the micromirror is able to interpose itself either between the output of the first input optical guide and the inputs of the first and second output optical guides, or between the output of the second input optical guide and the inputs of the third and fourth output optical guides.

Therefore, when the light beam conveyed by guide 31 is reflected towards guide 35, the light beam conveyed by guide 31′ is transmitted to guide 37′. Similarly, when the light beam conveyed by guide 31 is transmitted to guide 37, the light beam conveyed by guide 31′ is reflected towards guide 35′.

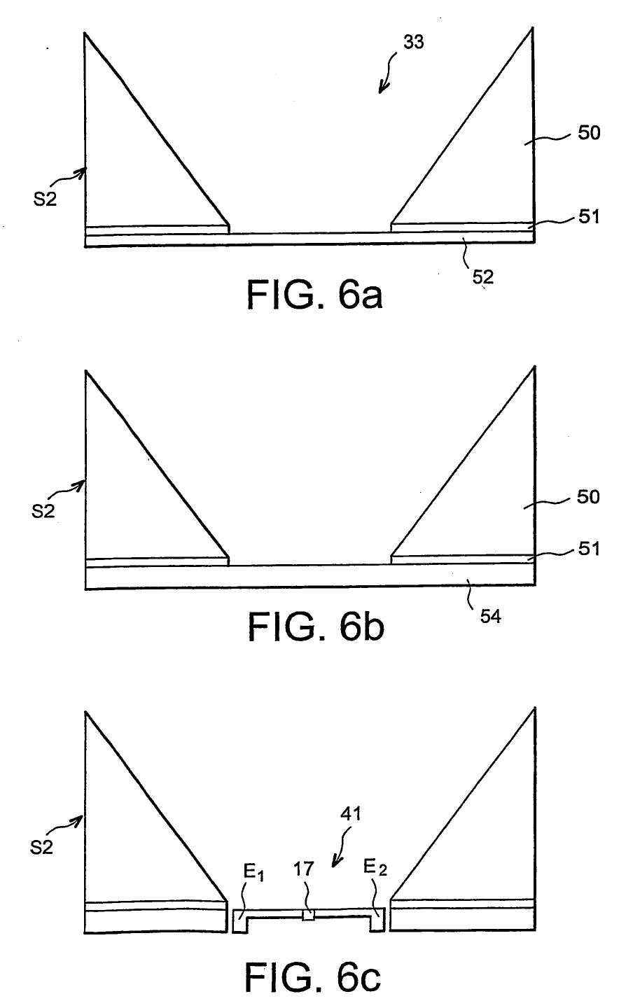

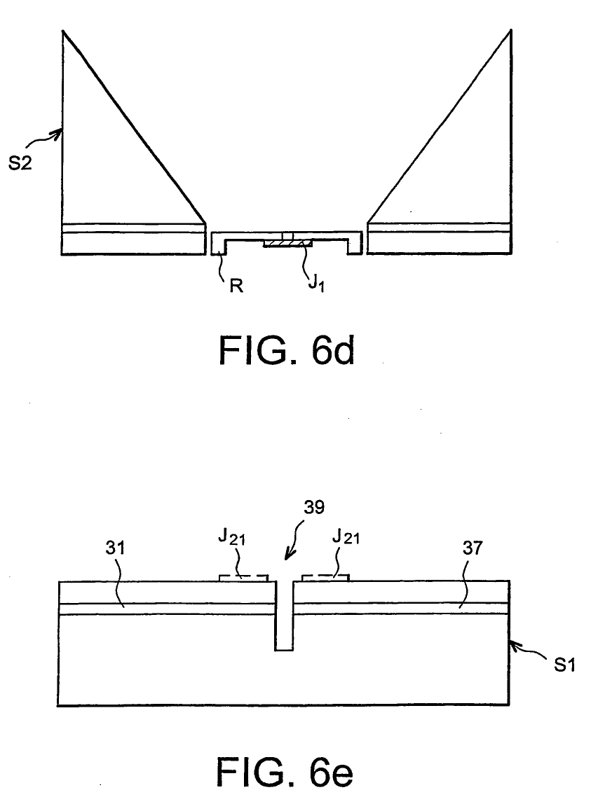

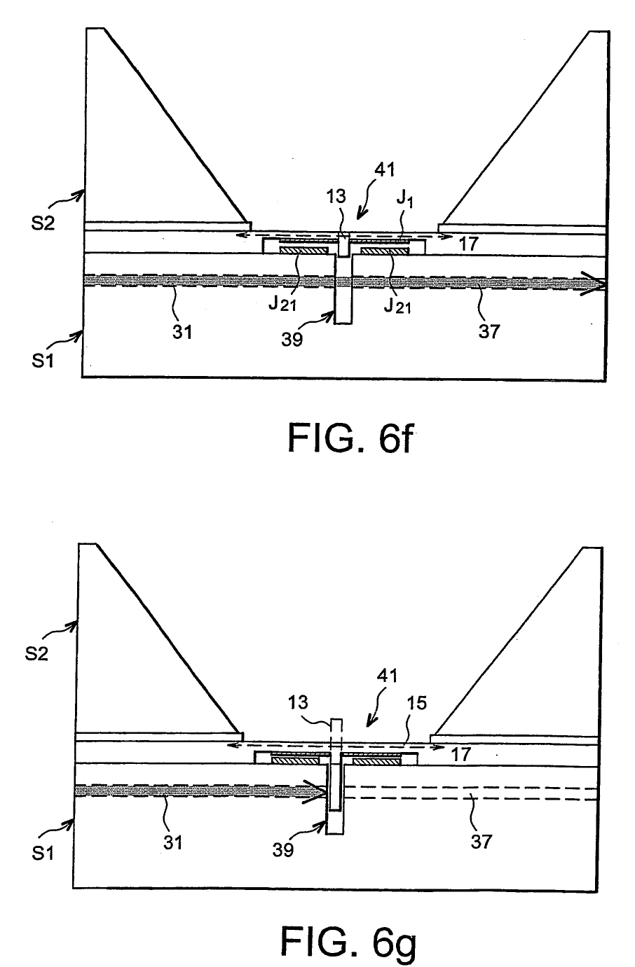

FIGS. 6a to 6g illustrate an example of embodiment of the switch shown FIGS. 3a to 3c. FIGS. 6a to 6d are cross-sections along a plane parallel to the tilt plane and show the fabrication of the micromirror in a substrate S2, FIG. 6e shows the preparation of substrate S1 comprising the optical guides and FIGS. 6f and 6g are cross-sections in a plane perpendicular to the tilt plane of the switch after adding the micromirror onto substrate S1.

In FIG. 6a a substrate S2 is shown which, in this example, is formed by a wafer of SOI type which corresponds to a stack of three layers: a silicon layer 50, a silica layer 51 and a thin film of advantageously monocrystalline silicon 52.

Etching was performed in silicon layer 50 then in silica layer 51 to obtain an opening 33. Etching of layer 50 may be made along preferential crystallographic planes using the silica layer as stop layer; this etching is anisotropic chemical etching for example of KOH type so as to obtain an opening of conical shape, and etching of layer 51 may be performed using dry anisotropic etching of reactive ion etching type using fluorinated gases.

The silica layer could have been maintained in opening 33.

FIG. 6b shows an epitaxy step of silicon film 52; this step enables adaptation of the thickness of the silicon layer to the desired thickness of the micromirror to be fabricated. Evidently, if the initial thickness of film 52 is sufficient, this epitaxy is not necessary.

By way of example, the thickness of silicon layer 54 obtained after epitaxy lies between 5 and 50 μm for example depending upon the mechanical characteristics and the reflective surface involved.

FIG. 6c shows the fabrication of the micromirror by etching layer 54 in an appropriate pattern.

To achieve this two etchings are conducted, for example:
a first etching to hollow out the central part of the micromirror,
a second etching to release the micromirror from the remainder of layer 54 (the actuating part is only joined to layer 54 by the narrow zone corresponding to the hinge of the actuating part).

The first etching must be conducted starting from the face of film 54 opposite the face present in opening 33. This etching is made through an appropriate mask (not shown) and in particular enables thinning of film 54 outside the zones intended to form the two ends E1 and E2 of the reflector part.

The second etching can be made starting from either one of the faces of layer 54. The mask (not shown) used for this etching must allow etching of layer 54 over its entire remaining thickness so as to obtain the contour of the micromirror, i.e. the reflector part and the mobile part such as shown in the overhead view in FIG. 3a or FIG. 4b in which a limit stop is used.

The first and second etchings are chosen independently from one another from among anisotropic chemical etching for example with a KOH solution or dry anisotropic etching, for example reactive ion etching using SF₆ fluorinated gases.

With these etchings it is possible to obtain good surface quality since they are used to fabricate the side face of the micromirror.

After this step, as shown FIG. 6d, on the reflector part or at least on the side face, a reflective material is deposited such as aluminium or gold or even dielectric multilayers deposited by cathode vapour or sputtering. In this manner the reflective surface of the micromirror is fabricated. Also, a conductive deposit is made in the hollowed out part of the micromirror, more precisely underneath the mobile part using a pattern such as shown in perspective in FIG. 3c. This gives electrode J1. This conductive deposit is made for example by depositing a layer of metallic material such as aluminium, gold, chromium, etc. then etching this layer. At the same time as this electrode is formed, the electrical connection (not shown) of this electrode to supply means is also made.

If layer 54 is itself conductive as is the case with silicon, then this conductive deposit is not necessary and that part of layer 54 corresponding to the actuating part itself forms the electrode.

FIG. 6e shows a cross-section of substrate S1 along a plane containing input guide 31 and output guide 37. The optical guides may be made in the substrate using any integrated optics technique, and in particular using ion exchange techniques in glass, or silica depositing techniques on silicon or on glass or on fused silica.

A recess 39 is also made in the substrate, with a glass substrate for example this recess may be obtained by chemical type etching using hydrofluoric acid through a mask (not shown).

For a silica or semiconductor substrate, this recess is preferably made using dry anisotropic etching so as to obtain etch flanks having very good perpendicularity relative to the surface of the substrate.

This recess may also be made by mechanical sawing such as polishing-sawing.

Also, on the surface of S1 (before or after forming the recess) a conductive deposit is made which is etched to obtain electrodes J12 and J22 of set J2.

This deposit is a layer of metallic material for example such as aluminium or gold, chromium deposited by cathode vapour or sputtering and etched by chemical etching or reactive ion etching so as to obtain the two electrodes J21 and J22. At the same time as this electrode is made, the electric connections (not shown) of these electrodes to supply means are also made.

FIGS. 6f and 6g illustrate the switch of the invention after adding substrate S2 onto substrate S1 so that the micromirror lies opposite the recess and in particular so that the reflector part may have a tilting movement within this recess.

In FIG. 6f, the reflector part of the micromirror is in top position, in other words the reflective surface does not intercept the optical axis of guides 31 and 37, and the light beam conveyed by guide 31 is transmitted directly via recess 39 to guide 37.

In FIG. 6g, the reflector part of the micromirror is in bottom position, in other words the reflective face in recess 39 intercepts the optical axis of guide 31 and the light beam conveyed by guide 31 is reflected by the reflective face towards guide 35 which does not lie in the cross section of FIG. 6g.

Adding substrate S2 onto substrate S1 may be made using any known technique, in particular by molecular bonding or any appropriate cementing technique (a bead of polymer cement for example) or further by brazing.

A stack of substrate S2 such as shown in FIG. 6a may also be made using a silicon carrier on which thermal oxidation is conducted to form the silica layer and finally a deposit of polycrystalline silicon of suitable thickness to fabricate the micromirror.

In this example of embodiment, substrate S2 is added onto substrate S1 after fabrication of the micromirror; evidently, substrate S2 may be added onto substrate S1 before the fabrication of said micromirror or at least before its release so that this addition can be conducted with a mechanically more rigid structure.

The examples of embodiment previously described concern switches in integrated optics using optical guides. Evidently, as seen above, the switch of the invention may be made in free space. In this case, the input and output guides are optical fibres which may be arranged in a substrate in which rails have been cut (“V” grooves for example) to hold said fibres in position. A recess for movement of the micromirror may also be provided between the ends of the fibres. The micromirror may, as for the case in which optical guides are arranged on an independent substrate, be added onto the substrate of fibres.

1. An optical switch comprising:
a first input optical path;
a first and a second output optical paths;
a control device; and
a micromirror movable between an output of the first input optical path and inputs of the first and second output optical paths, the first input optical path and the first output optical path having an identical first optical axis, and the second output optical path having a second optical axis, the first and second optical axes respectively forming an angle relative to an axis of symmetry,
wherein the micromirror comprises:
a reflector part and an actuating part,
the actuating part having an axis of rotation, the actuating part being configured to drive the reflector part in rotation about a tilt plane, the tilt plane being substantially perpendicular to a plane containing the axis of rotation, and
the reflector part including a reflective face in a plane substantially parallel to the tilt plane, the reflective face being configured to reflect a light wave coming from the first input path towards the second output path,
wherein the control device is configured to tilt the reflector part, the control device comprising a first set of electrodes arranged on the actuating part, a second set of electrodes facing the first set of electrodes, the first and second set of electrodes adapted to having a potential difference applied thereacross.

2. An optical switch as in claim 1, further comprising a second input optical path associated with a third and fourth output optical paths,
wherein the micromirror is configured to interpose between one of an output of the first input optical path and inputs of the first and second output optical paths and between an output of the second input optical path and inputs of the third and fourth output optical paths.

3. An optical switch as in claim 1, wherein the first optical path and the first and second output optical paths are selected from the group comprising optical fibres and optical guides.

4. An optical switch as in claim 1, wherein the first input optical path and the first and second output optical paths are optical guides in a first substrate, said first substrate comprising a recess configured to allow the reflector part to rotate about the tilt plane.

5. An optical switch as in claim 1, wherein the angle is different from zero.

6. An optical switch as in claim 1, wherein each set of electrodes comprises at least one electrode.

7. An optical switch the micromirror comprises at least one limit stop configured to limit a movement of the reflector part.

8. An optical switch as in claim 7, wherein the limit stop is formed by a boss disposed at one end of the reflector part, and the width of the boss in a plane substantially perpendicular to the tilt plane is greater than the width of a recess along the same plane.

9. A method for fabricating an optical switch, comprising:
fabricating, in a first substrate, a first input optical guide, a first and a second output optical guides, a recess and a second set of electrodes, the first input optical guide and the first output optical guide having an identical first optical axis, the second output optical guide having a second optical axis, the first and the second optical axes respectively forming an angle δ relative to an axis of symmetry;
fabricating, in a second substrate, a micromirror and a first set of electrodes, the micromirror being movable between an output of the input optical guide and inputs of the first and second output optical guides, the micromirror comprising a reflector part and an actuating part having an axis of rotation, the actuating part being configured to drive the reflector part in rotation about a tilt plane, the tilt plane being substantially perpendicular to a plane containing the axis of rotation, and the reflector part comprising at least one reflective face in a plane substantially parallel to the tilt plane, the reflective face being configured to reflect a light wave coming from the first input optical guide towards the second output optical guide; and
adding the second substrate onto the first substrate so that the micromirror is tiltable within the recess.

10. A method for fabricating an optical switch as in claim 9, wherein the second substrate is a stack of a first carrier layer, a second layer and a third layer.

11. A method for fabricating an optical switch as in claim 10, wherein the first carrier layer is a layer of silicon, the second layer is a layer of silicon oxide and the third layer is a silicon film, the micromirror being fabricated in the silicon film.

12. A method for fabricating an optical switch as in claim 11, wherein the silicon film is a monocrystalline silicon film.

13. A method for fabricating an optical switch as in claim 10, wherein fabricating, in a second substrate, the micromirror and the first set of electrodes, comprises:
etching the first carrier layer and etching the second layer so as to make an opening in the second substrate exposing part of the third layer;
etching the third layer so as to form patterns corresponding to the reflector part and the actuating part of the micromirror, and so as to release the reflector and actuating parts from the remainder of the third layer to allow the third layer to subsist at the axis of rotation of the actuating part so that the micromirror remains joined to the second substrate; and
depositing a reflective layer on at least a portion of a side face of the reflector part so as to form the reflective face of the micromirror.

14. A method for fabricating an optical switch comprising:
etching a first layer and a second layer of a substrate so as to make an opening in the first layer and the second layer to expose an area of a third layer of the substrate;
etching the third layer to form a micromirror comprising a reflector part and an actuating part such that the reflector part and the actuator part are released from a remainder of the third layer and a portion of the third layer forms a hinge connecting the actuator part to the third layer; and
depositing a reflective layer on a surface of the reflective part to form a reflective surface of the micromirror.

15. A method for fabricating an optical switch as in claim 14, wherein the actuating part is configured to rotate the reflector part around a rotation axis of the hinge portion.

16. A method for fabricating an optical switch as in claim 14, wherein the reflector part is rotatable about a tilt plane substantially perpendicular to a plane containing the rotation axis of the hinge portion and the reflective surface of the reflector part is in a plane substantially parallel to the tilt plane.

17. A method for fabricating an optical switch as in claim 14, wherein the first carrier layer is a layer of silicon, the second layer is a layer of silicon oxide and the third layer is a silicon film.

18. A method for fabricating an optical switch as in claim 14, further comprising:
fabricating an input optical guide, a first output optical guide, a second output optical guide, and a recess in a support substrate such that the first input optical guide and the first output optical guide have a common first optical axis, the second output optical guide has a second optical axis and the first and second optical axes form an angle.

19. A method for fabricating an optical switch as in claim 18, further comprising depositing the substrate from which the micromirror is formed on the support substrate from which the optical guides are fabricated such that the micromirror is tiltable within the recess.

20. A method for fabricating an optical switch as in claim 19, wherein the reflective part of the micromirror is movable between an output of the input optical guide and inputs of the first and second output optical guides.
